(19) United States
(12) Patent Application Publication
(10) Pub. No.: US 2026/0221834 A1
(43) Pub. Date: Jul. 30, 2026

(54) STATOR OF AN AXIAL FLUX ELECTRIC MACHINE

(71) Applicant: VALEO ELECTRIFICATION, Creteil Cedex (FR)

(72) Inventors: Khadija EL BARAKA, Creteil Cedex (FR); Svetislav JUGOVIC, Creteil Cedex (FR)

(73) Assignee: VALEO ELECTRIFICATION, Creteil Cedex (FR)

(21) Appl. No.: 19/139,910

(22) PCT Filed: Dec. 8, 2023
(86) PCT No.: PCT/EP2023/084970

§ 371 Date: Jun. 17, 2025

(30) Foreign Application Priority Data
Dec. 22, 2022 (FR) FR2214195

(51) Int. Cl. H02K 3/52; H02K 1/14; H02K 1/2798; H02K 21/24

(52) U.S. Cl. CPC H02K 3/522; H02K 1/146; H02K 1/2798; H02K 21/24; H02K 2203/09

(57) ABSTRACT

A stator of an axial flux electric machine, the axial flux electric machine having an axis of rotation. The stator includes
a plurality of electrical windings, a plurality of teeth each supporting one of the electrical windings. A multifunctional support, or interconnection support, configured to support the plurality of teeth, and said multifunctional support being provided with electrical interconnection conductors arranged to be connected to the electrical windings.

The present invention relates to a stator of an axial flux electric machine, and to such an axial flux electric machine, in particular configured to contribute to the propulsion of an electric vehicle.

Patent application WO2016113567 discloses an axial flux machine that comprises a stator comprising a stator housing containing a plurality of stator windings positioned circumferentially about an axis of rotation of the axial flux machine. The axial flux machine further comprises a pair of rotors each comprising a set of permanent magnets, and these rotors are rotatably mounted about the axis of rotation of the axial flux machine. Each rotor is spaced apart from the stator along the axis of the machine, in order to define an air gap between the stator and each rotor. The rotors are positioned on either side of the windings of the stator. The magnetic flux in the machine is generally oriented along the axial direction in the air gap.

The invention aims in particular to improve the operations to assemble the teeth of a stator during manufacturing and the retention of the teeth on the axial flux electric machine over the life of the axial flux electric machine.

The invention thus relates to a stator of an axial flux electric machine, the axial flux electric machine having an axis of rotation, the stator comprising:
a plurality of electrical windings,
a plurality of teeth each holding one of the electrical windings,
a multifunctional support, or interconnection support, configured to hold the plurality of teeth, this multifunctional support being provided with electrical interconnection conductors arranged to be connected to the electrical windings.

This multifunctional support according to the invention makes it possible to reduce the number of parts necessary to manufacture the axial flux electric machine. It is thus possible to simplify the manufacturing of the axial flux electric machine and better manage the footprint of this axial flux electric machine. The invention further makes it possible to securely retain the teeth, by means of the multifunctional support, during the manufacturing of the machine and during the life of the electric machine.

The windings on the teeth together form an overall winding of the stator, for example of the three-phase type.

According to one of the aspects of the invention, the multifunctional support comprises a plurality of seats on each of which a tooth bears.

According to one of the aspects of the invention, the tooth seats are positioned about the axis of rotation, in particular evenly.

According to one of the aspects of the invention, each tooth of the plurality of teeth is in one piece, that is, made from a single part.

According to one of the aspects of the invention, each seat is delimited by two radial branches of the multifunctional support.

According to one of the aspects of the invention, each tooth is positioned circumferentially between two neighboring radial branches.

According to one of the aspects of the invention, each tooth comprises a core around which the winding is formed and extending along the axis of rotation and, at each axial end thereof, an end portion extending transversely to the core.

According to one of the aspects of the invention, each end portion substantially defines a T shape with the core. The end portion is used to mechanically fasten the tooth to the multifunctional support or to a stator housing.

According to one of the aspects of the invention, each end portion has an outer main face that is generally planar and oriented in the opposite direction to the core.

According to one of the aspects of the invention, this outer main face extends perpendicularly to the axis of rotation of the axial flux electric machine.

According to one of the aspects of the invention, the end portion of the tooth extends at least partially in a circumferential space between two neighboring radial branches of the multifunctional support.

The tooth is thus axially close to the neighboring rotor, which makes it possible to reduce the air gap between the stator and the rotor.

This improves the electromechanical performance of the machine.

According to one of the aspects of the invention, the end portion of the tooth passes through the circumferential space, coming substantially flush with the radial branches on the air gap side.

On the air gap side, the radial branches of the multifunctional support thus do not protrude axially beyond the end portions of the teeth, and the outer main face of the end portion of the tooth substantially continues on from the radial branches. In another exemplary embodiment of the invention, the radial branches of the multifunctional support are axially set back from the end portions of the teeth. In other words, the end portions of the teeth protrude further, axially in the air gap, than the radial branches of the multifunctional support.

According to one of the aspects of the invention, the radial branches of the seat of the multifunctional support are flat, extending in particular perpendicularly to the axis of rotation.

According to one of the aspects of the invention, the branches extend in a straight line, in the radial direction.

According to another of the aspects of the invention, one of the radial branches is provided with a reinforcing rib. This radial branch can thus have a T-shaped transverse cross-section. This shape makes it possible to increase the stiffness of the radial branches.

According to one of the aspects of the invention, the multifunctional support comprises a central hub and an outer ring, and the radial branches defining the seats extend radially between this central hub and the outer ring.

According to one of the aspects of the invention, the central hub comprises a central opening configured to allow a rotary shaft connected to a rotor or a plurality of rotors of the axial flux electric machine to pass through.

According to one of the aspects of the invention, the outer ring comprises a cylindrical outer skirt the axis of which is parallel to the axis of rotation.

According to one of the aspects of the invention, the outer ring comprises a cylindrical inner skirt having an axis parallel to the axis of rotation.

According to one of the aspects of the invention, the inner and outer skirts are parallel to each other and are connected to each other by a planar circumferential band so that the outer ring has a U-shaped transverse cross-section.

According to one of the aspects of the invention, the electrical conductors of the multifunctional support to which the windings are connected are placed between the inner and outer skirts of the outer ring.

According to one of the aspects of the invention, the radial branches are connected to the inner skirt of the outer ring.

The radial branches thus extend between the central hub and this inner skirt of the outer ring.

According to one of the aspects of the invention, the seat of each tooth comprises at least one bearing zone on which the tooth bears, in particular an end portion of the tooth.

According to one of the aspects of the invention, the end portion of the tooth comprises an edge bearing on this bearing zone of the seat.

According to one of the aspects of the invention, the bearing zone of the seat is formed on the central hub or the outer ring or one of the radial branches of the multifunctional support.

According to one of the aspects of the invention, the seat of each tooth comprises at least two bearing zones on which the tooth bears, in particular an end portion of the tooth.

According to one of the aspects of the invention, these two bearing zones of the seat are radially spaced apart from each other, and the end portion of the tooth comprises a radially inner edge and a radially outer edge each bearing on one of the bearing zones of the seat.

According to one of the aspects of the invention, the end portion of the tooth comprises two circumferentially spaced apart lateral edges that form, with the radially inner and radially outer edges, the perimeter of this end portion of the tooth.

According to one of the aspects of the invention, the two lateral edges of the end portion of the tooth are facing the circumferential space between two neighboring radial branches of the multifunctional support.

In other words, the tooth does not bear on the radial branches of the multifunctional support, but only on the two bearing zones.

According to one of the aspects of the invention, the two bearing zones of the seat are formed respectively on the central hub and on the outer ring.

According to one of the aspects of the invention, each bearing zone is a circumferential band that extends from one of the radial branches to one of the neighboring radial branches.

According to one of the aspects of the invention, the radial dimension of the bearing zone is less than 20%, in particular less than 10%, of the radial dimension of the radial branch.

The bearing zone thus has a fairly small radial dimension compared to that of the radial branches.

According to another of the aspects of the invention, these two bearing zones are circumferentially spaced apart from each other, and the end portion of the tooth comprises two lateral edges circumferentially spaced apart from each other, each bearing on one of the bearing zones of the seat.

According to one of the aspects of the invention, the end portion of the tooth comprises a radially inner edge and a radially outer edge that form, with the lateral edges, the perimeter of this end portion of the tooth.

According to one of the aspects of the invention, the radially inner edge and the radially outer edge of the end portion of the tooth are facing the circumferential space between two neighboring radial branches of the multifunctional support.

In other words, the tooth does not bear on the central hub and the outer ring of the multifunctional support, but only on the two bearing zones.

According to one of the aspects of the invention, the two bearing zones of the seat are formed respectively on two neighboring radial branches.

According to one of the aspects of the invention, each bearing zone is a radial band that extends on one of the radial branches, substantially from the central hub to the outer ring.

Two bearing zones are thus formed on each radial branch, for two neighboring teeth respectively.

According to one of the aspects of the invention, the radial branch comprises a reinforcing rib that is radial and extends, in particular in a straight line, between the two neighboring bearing zones of this radial branch.

According to one of the aspects of the invention, this radial branch thus has a T-shaped cross-section.

According to one of the aspects of the invention, the end portion of the tooth comprises, along each lateral edge, a shoulder configured to bear on one of the bearing zones of the seat, and between these shoulders, the end portion of the tooth extends in the circumferential space between two neighboring radial branches of the multifunctional support.

According to one of the aspects of the invention, each tooth comprises a core around which the winding is formed and extending along the axis of rotation and, at each axial end thereof, an end portion extending transversely to the core, the end portion having an outer main face that is oriented in the opposite direction to the core and comprises a groove in a central region of this outer main face, which central region is circumferentially spaced apart from two lateral edges of the end portion, this groove being configured to reduce the torque ripple that may occur during the operation of the axial flux electric machine.

According to one of the aspects of the invention, the two end portions of the tooth are symmetrical to each other along a plane of symmetry perpendicular to the axis of rotation.

According to one of the aspects of the invention, the multifunctional support comprises at least one positioning relief protruding into the circumferential space between two neighboring radial branches of the multifunctional support, this positioning relief being arranged to interact with the tooth, in particular the end portion of the tooth.

According to one of the aspects of the invention, the relief extends from one of the radial branches, in particular substantially in the middle of this radial branch.

According to one of the aspects of the invention, each circumferential space is associated with two facing positioning reliefs, belonging respectively to the two branches on either side of this circumferential space.

According to another of the aspects of the invention, the positioning relief extends from the central hub or the outer ring of the multifunctional support.

According to one of the aspects of the invention, each circumferential space is associated with two facing positioning reliefs, belonging respectively to the central hub and the outer ring of the multifunctional support.

According to one of the aspects of the invention, the positioning relief is in the form of a ridge.

According to one of the aspects of the invention, the multifunctional support comprises a one-piece body, in particular made from plastic, in particular by molding, and this one-piece body comprises the radial branches, the hub, and the outer ring.

The invention facilitates the construction of the axial flux electric machine, as a small number of parts is used, including the aforementioned one-piece body.

According to one of the aspects of the invention, the electrical conductors of the multifunctional support are conductive bars.

According to one of the aspects of the invention, these conductive bars are held by the one-piece body of the support.

According to one of the aspects of the invention, the conductive bars are held by the outer ring of the multifunctional support.

According to one of the aspects of the invention, the conductive bars have a circular shape, which substantially follows the shape of the outer ring.

According to one of the aspects of the invention, the conductive bars each comprise a tab for electrical connection to one of the electrical winding wires.

According to one of the aspects of the invention, this connecting tab extends axially, parallel to the axis of rotation.

According to one of the aspects of the invention, the outer ring thus holds a plurality of connecting tabs distributed about the axis of rotation.

According to one of the aspects of the invention, these bars are at least partially embedded in a resin held by the outer ring, in particular between the inner and outer skirts thereof.

According to one of the aspects of the invention, the multifunctional support, in particular the one-piece body, comprises a compartment formed on the outer ring, and configured to receive the electrical output ends of the conductive bars so as to enable the electrical connection of these conductive bars to an external electrical device.

According to one of the aspects of the invention, the stator comprises a housing configured to interact with the multifunctional support so as to trap the teeth between this multifunctional support and this housing.

According to one of the aspects of the invention, the housing and the multifunctional support are fastened together by means of fastening members such as screws.

According to one of the aspects of the invention, the multifunctional support is fully housed in an inner volume of the housing.

According to one of the aspects of the invention, a cover is provided to close the housing.

According to one of the aspects of the invention, this cover is generally flat, and extends perpendicularly to the axis of rotation.

According to one of the aspects of the invention, this cover is fastened to an annular end edge of the housing, in particular by means of fastening members such as screws.

According to one of the aspects of the invention, a seal, in particular annular, is placed between this end of the housing and the cover.

According to one of the aspects of the invention, a rotor, housed in the housing, is positioned axially between the multifunctional support and this cover.

According to one of the aspects of the invention, the housing comprises a plurality of seats on each of which a tooth bears.

According to one of the aspects of the invention, the seats of the housing are positioned about the axis of rotation, in particular evenly.

Each tooth is thus sandwiched between a seat of the housing and a seat of the multifunctional support.

According to one of the aspects of the invention, the seat of the housing and the seat of the multifunctional support have an identical surface.

According to one of the aspects of the invention, each seat is delimited by two radial branches of the housing.

According to one of the aspects of the invention, each tooth is positioned circumferentially between two neighboring radial branches.

According to one of the aspects of the invention, the end portion of the tooth extends at least partially in a circumferential space between two neighboring radial branches of the housing.

The tooth is thus axially close to the neighboring rotor, which makes it possible to reduce the air gap between the stator and the rotor.

This improves the electromechanical performance of the machine.

According to one of the aspects of the invention, the end portion of the tooth passes through the circumferential space, coming substantially flush with the radial branches on the air gap side.

On the air gap side, the radial branches of the multifunctional support thus do not protrude axially beyond the end portions of the teeth, and the outer main face of the end portion of the tooth substantially continues on from the radial branches.

According to one of the aspects of the invention, the radial branches of the seat of the housing are flat, extending in particular perpendicularly to the axis of rotation.

According to one of the aspects of the invention, the branches extend in a straight line, in the radial direction.

According to another of the aspects of the invention, one of the radial branches is provided with a reinforcing rib. This radial branch can thus have a T-shaped transverse cross-section, for example.

According to one of the aspects of the invention, the housing comprises an inner annular wall and an outer annular wall, and the radial branches defining the seats extend radially between this inner annular wall and the outer annular wall.

According to one of the aspects of the invention, the seat for each tooth comprises at least one bearing zone on which the tooth bears, in particular an end portion of the tooth.

According to one of the aspects of the invention, the end portion of the tooth comprises an edge bearing on this bearing zone of the seat.

According to one of the aspects of the invention, the bearing zone of the seat is formed on the inner annular wall or the outer annular wall or one of the radial branches of the housing.

According to one of the aspects of the invention, the seat of each tooth comprises at least two bearing zones on which the tooth bears, in particular an end portion of the tooth.

According to one of the aspects of the invention, these two bearing zones of the seat are radially spaced apart from each other, and the end portion of the tooth comprises a radially inner edge and a radially outer edge each bearing on one of the bearing zones of the seat.

According to one of the aspects of the invention, the end portion of the tooth comprises two circumferentially spaced apart lateral edges that form, with the radially inner and radially outer edges, the perimeter of this end portion of the tooth.

According to one of the aspects of the invention, the two lateral edges of the end portion of the tooth are facing the circumferential space between two neighboring radial branches of the housing.

In other words, the tooth does not bear on the radial branches of the housing, but only on the two bearing zones.

According to one of the aspects of the invention, the two bearing zones of the seat are formed respectively on the inner annular wall and on the outer annular wall.

According to one of the aspects of the invention, each bearing zone is a circumferential band that extends from one of the radial branches to one of the neighboring radial branches.

According to one of the aspects of the invention, the radial dimension of the bearing zone is less than 20%, in particular less than 10%, of the radial dimension of the radial branch.

The bearing zone thus has a fairly small radial dimension compared to that of the radial branches.

According to another of the aspects of the invention, these two bearing zones of the housing are circumferentially spaced apart from each other, and the end portion of the tooth comprises two lateral edges circumferentially spaced apart from each other, each bearing on one of the bearing zones of the seat.

According to one of the aspects of the invention, the end portion of the tooth comprises a radially inner edge and a radially outer edge that form, with the lateral edges, the perimeter of this end portion of the tooth.

According to one of the aspects of the invention, the radially inner edge and the radially outer edge of the end portion of the tooth are facing the circumferential space between two neighboring radial branches of the housing.

In other words, the tooth does not bear on the inner annular wall and the outer annular wall of the housing, but only on the two bearing zones formed respectively on two neighboring radial branches.

According to one of the aspects of the invention, each bearing zone is a radial band that extends on one of the radial branches, substantially from the inner annular wall to the outer annular wall.

Two bearing zones are thus formed on each radial branch, for two neighboring teeth respectively.

According to one of the aspects of the invention, the radial branch comprises a reinforcing rib that is radial and extends, in particular in a straight line, between the two neighboring bearing zones of this radial branch.

This radial branch thus has a T-shaped cross-section.

According to one of the aspects of the invention, the end portion of the tooth comprises, along each lateral edge, a shoulder configured to bear on one of the bearing zones of the seat, and between these shoulders, the end portion of the tooth extends in the circumferential space between two neighboring radial branches of the housing.

According to one of the aspects of the invention, the housing comprises at least one positioning relief protruding into the circumferential space between two neighboring radial branches of the housing, this positioning relief being arranged to interact with the tooth, in particular the end portion of the tooth.

According to one of the aspects of the invention, the positioning relief extends from one of the radial branches, in particular substantially in the middle of this radial branch.

According to one of the aspects of the invention, each circumferential space is associated with two facing positioning reliefs, belonging respectively to the two branches on either side of this circumferential space.

According to another of the aspects of the invention, the positioning relief extends from the inner annular wall or the outer annular wall of the housing.

According to one of the aspects of the invention, each circumferential space is associated with two facing positioning reliefs, belonging respectively to the inner annular wall and the outer annular wall of the housing.

According to one of the aspects of the invention, the positioning relief is in the

According to one of the aspects of the invention, the housing is for example made from plastic.

According to one of the aspects of the invention, the inner annular wall of the housing comprises a central opening configured to allow a rotary shaft connected to a rotor or a plurality of rotors of the axial flux electric machine to pass through.

According to one of the aspects of the invention, the housing comprises an inner annular shoulder on which the multifunctional support bears.

According to one of the aspects of the invention, this inner annular shoulder is formed on the outer annular wall of the housing.

According to one of the aspects of the invention, a rotor is placed facing the radial branches of the housing, outside the housing.

According to one of the aspects of the invention, the electrical winding on the tooth is formed by turns of electrical wire around the tooth.

The invention further relates to a multifunctional support for a stator of an axial flux electric machine, this multifunctional support, or interconnection support, being configured to hold a plurality of teeth of the stator each provided with a winding, and this multifunctional support being provided with electrical interconnection conductors arranged to be connected to the electrical windings.

The invention further relates to an axial flux electric machine, in particular of the permanent magnet type, comprising a stator as described above, and at least one rotor positioned face to face with the stator, in the axial direction.

According to one of the aspects of the invention, the axial flux electric machine is configured to operate in motor mode. In this case, the windings are configured to be electrically powered so as to generate a magnetic field capable of producing, with one or more rotors of the axial flux electric machine, an output torque. In this case, the axial flux electric machine can be used as a machine for propelling a vehicle.

According to another of the aspects of the invention, the axial flux electric machine is configured to operate in electrical generator mode.

According to another of the aspects of the invention, the axial flux electric machine is configured to operate alternately in generator mode and in motor mode as required.

According to one of the aspects of the invention, the permanent magnets are held by the rotor or rotors.

According to one of the aspects of the invention, the rotor comprises a plate holding a plurality of permanent magnets having an outline substantially in the shape of a disk sector.

According to one of the aspects of the invention, the magnets have a thickness that is less than the thickness of the plate, these thicknesses being measured along the axis of rotation.

According to one of the aspects of the invention, the machine comprises two rotors placed on either side of the stator, axially face to face with this stator.

According to one of the aspects of the invention, the electrical winding on the tooth is formed by turns of electrical wire around the tooth.

According to one of the aspects of the invention, a resin, in particular an epoxy resin, is present on the turns of the windings and in contact with the housing of the stator, so as to improve the strength of the windings and the heat conduction of these windings with the stator housing.

According to one of the aspects of the invention, the housing of the stator is arranged to hold an electrical connector for the electrical connection of the electrical interconnection conductors of the stator.

According to one of the aspects of the invention, the housing of the stator is arranged to hold a bearing, in particular a ball bearing, for the shaft of the rotor.

According to one of the aspects of the invention, the machine is arranged as a permanent magnet synchronous motor, in particular for propelling an electric vehicle.

The invention further relates to a method for manufacturing an axial flux electric machine, comprising the following steps:
providing a multifunctional support as described above,
placing the teeth on this multifunctional support, with an electrical winding wound on each corresponding tooth.

According to one of the aspects of the invention, the method comprises the following step:
soldering the ends of the electrical wires of the windings to the electrical interconnection conductors of the support.

According to one of the aspects of the invention, the method comprises the following step:
depositing a resin, in particular an epoxy resin, on the turns of the windings, so as to improve the strength of the windings and the heat conduction of these windings with the stator housing.

In addition, as is known, electric machines comprising an integrated permanent magnet rotor often exhibit torque ripple associated with the presence of cogging torque, which disrupts the output torque of the electric machine. Torque ripple is generated by the mutual attraction between a pole of the rotor and a pole of the stator, in particular between the magnets of the rotor and the teeth of the stator. Each time the ends of the magnets pass in front of a tooth of the stator, during the rotation of the rotor relative to the stator, the magnetic field leaks towards the stator, generating a cogging torque as it passes.

The invention aims to reduce these torque ripple and cogging torque effects in an axial flux electric machine.

The invention further relates, independently of or in combination with the above, to a stator of an axial flux electric machine, the machine having an axis of rotation, the stator comprising:
a plurality of electrical windings,
a plurality of teeth each holding one of the electrical windings, and each tooth comprises a core around which the winding is formed and extending along the axis of rotation and, at each axial end thereof, an end portion extending transversely to the core, the end portion having an outer main face that is oriented in the opposite direction to the core and comprises a groove in a central region of this outer main face, which central region is circumferentially spaced apart from two lateral edges of the end portion, this groove being configured to reduce the torque ripple that may occur during the operation of the axial flux electric machine.

Central region of the outer main face of the end portion of the tooth denotes a region that is circumferentially spaced apart from the two lateral edges of the end portion.

By virtue of the invention, in an axial flux electric machine, in particular a permanent magnet machine, it is possible, due to the groove in the central region of the outer main face, to reduce the torque ripple associated with the presence of cogging torque, which disrupts the output torque of the axial flux electric machine.

The electromechanical performance of the axial flux electric machine can thus be improved.

According to one of the aspects of the invention, the end portion of the tooth comprises a radially inner edge and a radially outer edge, these edges in particular being parallel, and the groove extends between these two radially inner and radially outer edges.

According to one of the aspects of the invention, the radially inner and radially outer edges are concentric.

According to one of the aspects of the invention, the ends of the groove join these radially inner and radially outer edges.

The groove thus passes fully across the end portion of the tooth, from the radially inner edge to the radially outer edge thereof.

According to one of the aspects of the invention, the groove is in the form of a straight line, along a radial direction of the stator.

Preferably, the groove has a radial dimension that is at least 50% of the overall radial dimension of the tooth.

In other words, in order to accomplish this role of reducing torque ripple, the groove must have a sufficient dimension in the radial direction.

This groove must not be reduced to a point, for example.

As a variant, the groove only joins one of the radially inner and radially outer edges, and remains at a non-zero distance from the other.

One of the ends of the groove is thus set back from one of these radially inner and radially outer edges, and this groove has for example a shorter radial dimension than the overall radial dimension of the tooth.

In another variant, the groove is set back from the two radially inner and radially outer edges.

This groove is thus not in contact with either of these radially inner and radially outer edges, and has a shorter radial dimension than the overall radial dimension of the tooth.

According to one of the aspects of the invention, the groove is continuous between the ends thereof.

As a variant, the groove is discontinuous between the ends thereof.

The groove is thus formed by a plurality of sections positioned one after the other with even or uneven spacing between these sections.

According to one of the aspects of the invention, the groove is straight and extends along a radial mid-line of the outer main face of the tooth.

The groove is thus centered on this outer main face.

According to one of the aspects of the invention, the groove extends in a curved shape, for example with one or more rounded bends.

According to one of the aspects of the invention, the groove is formed by a channel on the outer main face of the end portion of the tooth.

According to one of the aspects of the invention, the channel forming the groove has a depth substantially equal to half of the thickness of the end portion of the tooth.

This depth is measured parallel to the axis of rotation.

According to one of the aspects of the invention, the groove has a rectangular or trapezoidal or semi-circular transverse cross-section.

According to one of the aspects of the invention, the groove has a plurality of facets, in particular planar, which are contiguous along a bevel or a rounded portion.

According to one of the aspects of the invention, the outer main face of the end portion of the tooth has, in a central region, a plurality of grooves configured to reduce the torque ripple that may occur during the operation of the machine.

According to one of the aspects of the invention, these grooves extend radially, with an angular spacing between them.

According to one of the aspects of the invention, the groove is configured to interact with a positioning relief of a multifunctional support or a housing of the stator.

According to one of the aspects of the invention, this positioning relief comprises an intermediate radial branch of the multifunctional support or of the housing.

According to one of the aspects of the invention, the intermediate radial branch of the multifunctional support is positioned circumferentially between two radial branches defining a seat for the tooth.

This interaction between the groove of the tooth and this intermediate radial branch makes it possible to strengthen the mechanical retention of the tooth on the multifunctional support.

According to one of the aspects of the invention, the wire turns forming the winding extend between the two end portions of the tooth.

According to one of the aspects of the invention, the tooth has mirror symmetry along a plane of symmetry containing the axis of rotation.

As a variant, the tooth does not have mirror symmetry along a plane of symmetry containing the axis of rotation.

According to one of the aspects of the invention, each tooth comprises a stack of laminations, this stack being in particular radial.

According to one of the aspects of the invention, these laminations are electrical steel laminations, in particular grain-oriented electrical steel laminations.

According to one of the aspects of the invention, the orientation of the grains is parallel to the axis of rotation.

As a variant, each tooth is made from soft magnetic composite (SMC), in particular obtained by sintering.

Further features and advantages of the invention will become more clearly apparent on reading the following description, which is given by way of non-limiting illustrative example, and from the appended drawings, in which:

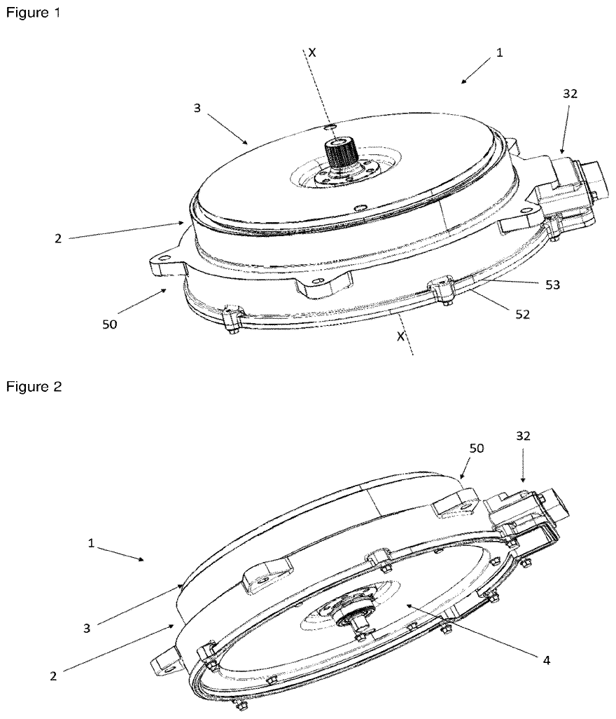

FIG. 1 schematically and partially illustrates a perspective view of an axial flux electric machine according to one exemplary embodiment of the invention;

FIG. 2 schematically and partially illustrates a perspective view of the axial flux electric machine in FIG. 1, without the cover;

FIG. 3 schematically and partially illustrates a perspective view of the axial flux electric machine in FIG. 1, without one of the rotors;

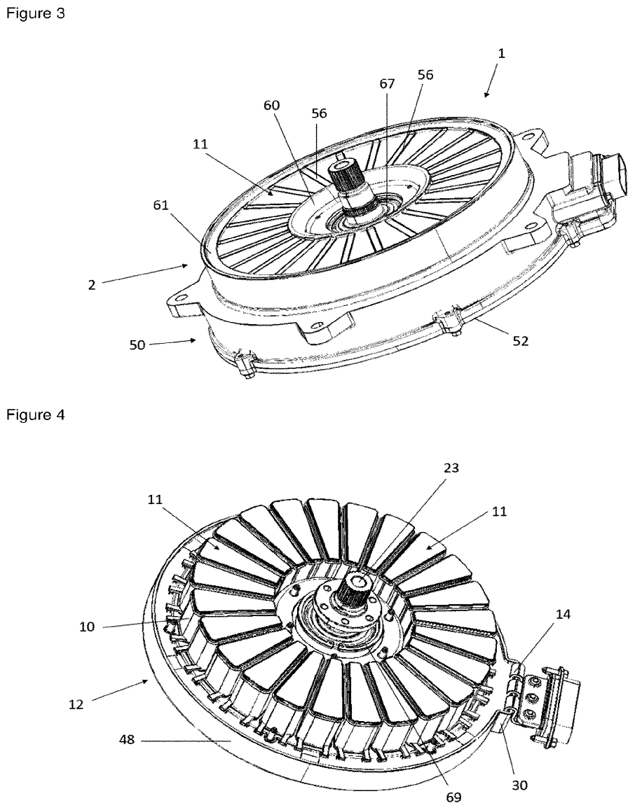

FIG. 4 schematically and partially illustrates a perspective view of the multifunctional support and the teeth of the stator of the axial flux electric machine in FIG. 1;

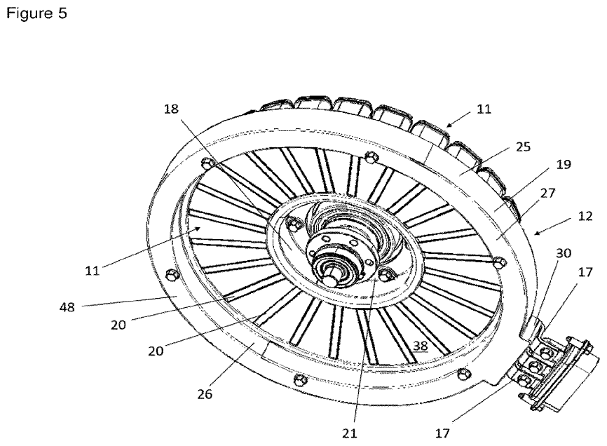

FIG. 5 schematically and partially illustrates another perspective view of the multifunctional support and the teeth of the stator of the axial flux electric machine in FIG. 1;

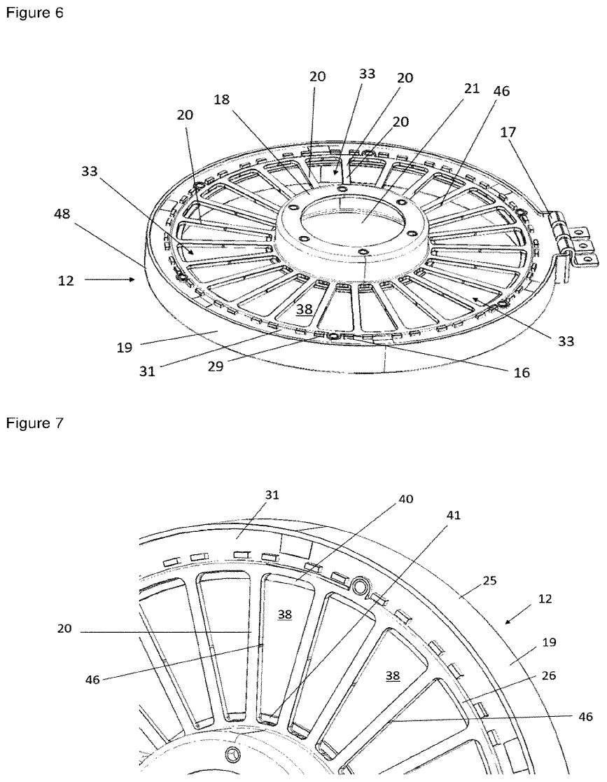

FIG. 6 schematically and partially illustrates a perspective view of the multifunctional support, without the teeth, of the stator in FIG. 4;

FIG. 7 schematically and partially illustrates a perspective view of a zone of the multifunctional support in FIG. 6;

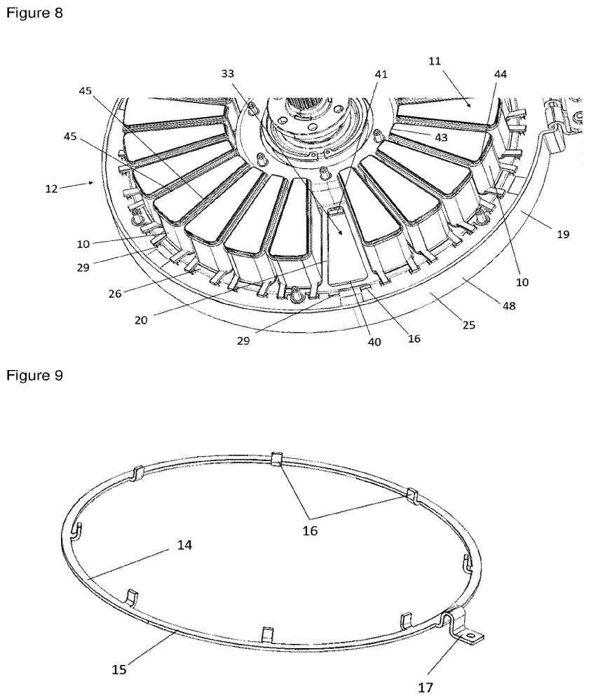

FIG. 8 schematically and partially illustrates a perspective view of the multifunctional support and the teeth of the stator in FIG. 4, with one tooth not shown;

FIG. 9 schematically and partially illustrates a perspective view of one of the electrical interconnection conductors of the multifunctional support in FIG. 4;

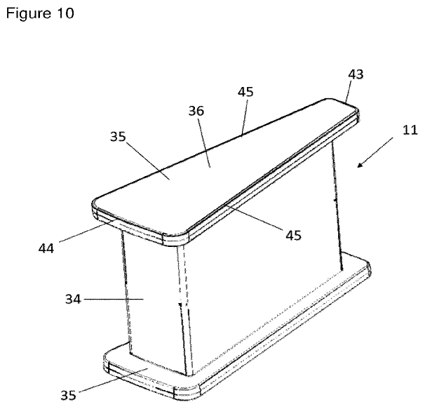

FIG. 10 schematically and partially illustrates a perspective view of one of the teeth of the stator in FIG. 4;

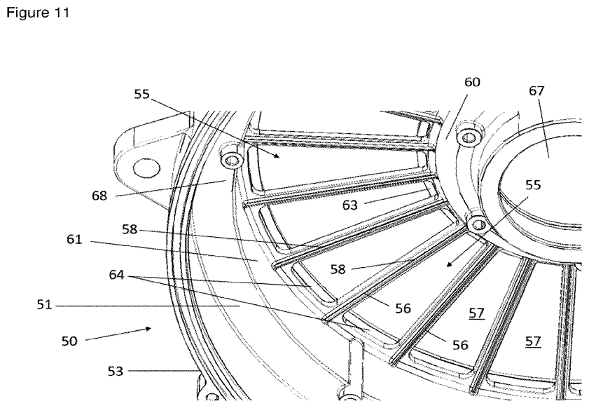

FIG. 11 schematically and partially illustrates a perspective view of the housing of the axial flux electric machine in FIG. 1;

FIG. 12 schematically and partially illustrates a perspective view of one of the rotors of the axial flux electric machine in FIG. 1;

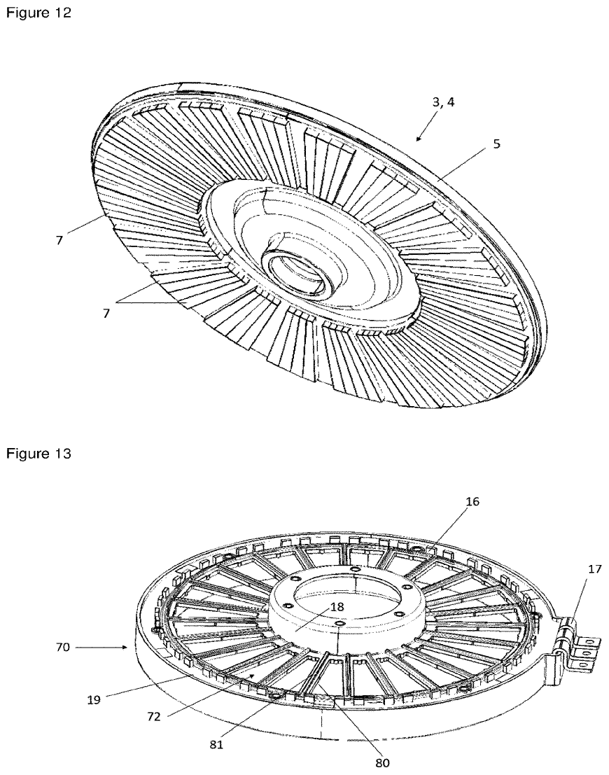

FIG. 13 schematically and partially illustrates a perspective view of a multifunctional support according to another exemplary embodiment of the invention;

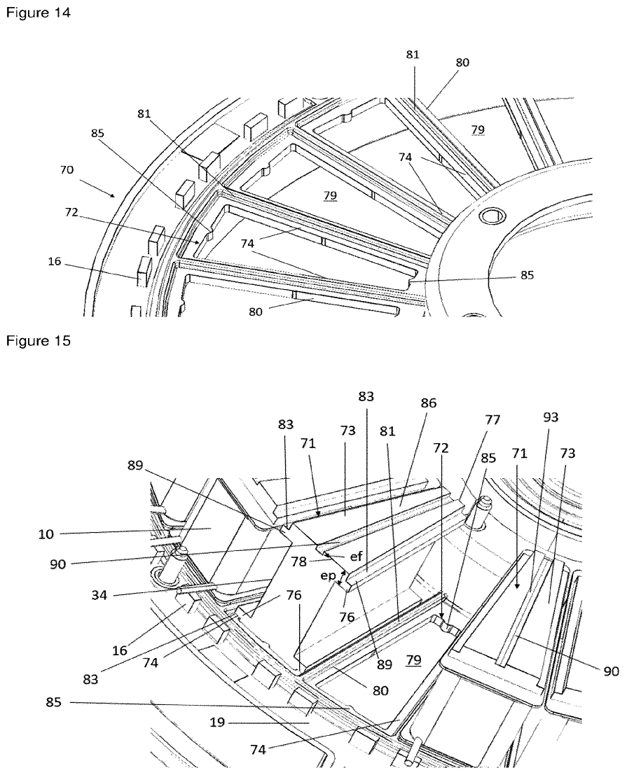

FIG. 14 schematically and partially illustrates a perspective view of a zone of the multifunctional support in FIG. 13;

FIG. 15 schematically and partially illustrates a perspective view of the multifunctional support in FIG. 13 and the teeth of the stator;

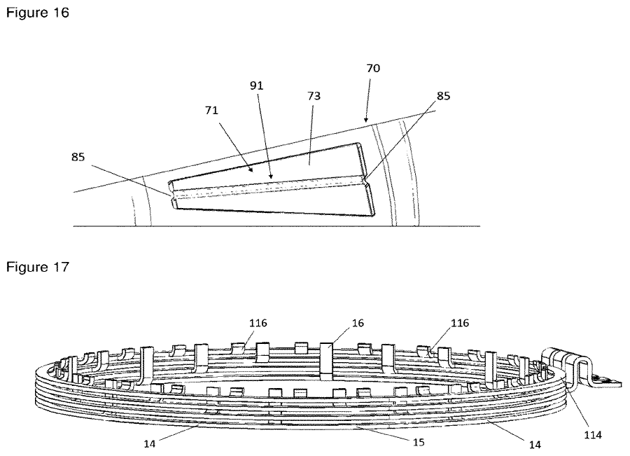

FIG. 16 schematically and partially illustrates a perspective view of a detail of the multifunctional support in FIG. 13 and one of the teeth of the stator;

FIG. 17 schematically and partially illustrates a perspective view of all of the electrical interconnection conductors of the multifunctional support in FIG. 4;

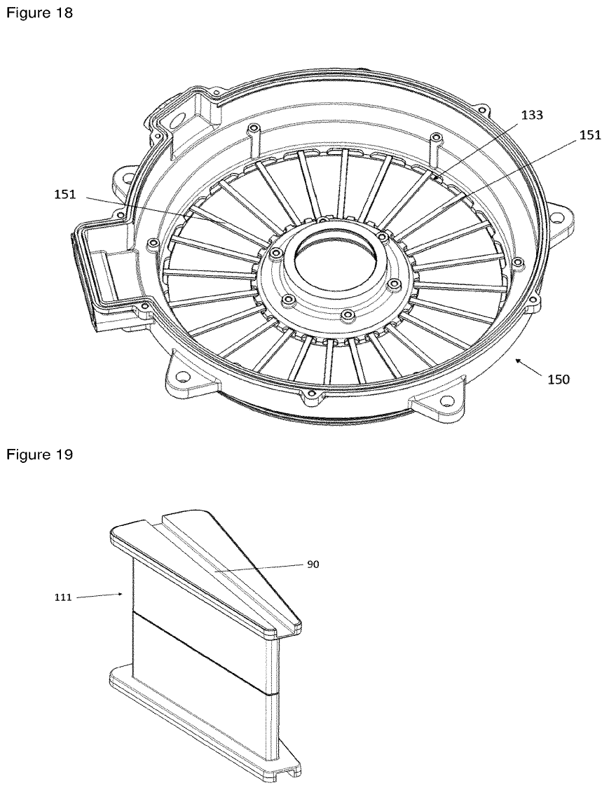

FIG. 18 schematically and partially illustrates a perspective view of the stator housing according to another exemplary embodiment of the invention;

FIG. 19 schematically and partially illustrates a perspective view of a tooth that interacts with the stator housing in FIG. 18.

FIGS. 1 and 2 show an axial flux electric machine 1 of the permanent magnet type, having an axis of rotation X, comprising a stator 2 and two rotors 3 and 4 placed on either side of the stator 2, axially face to face with this stator 2.

FIG. 2 does not show a cover on the stator 2 so as to show the rotor 4.

In the example described, the axial flux electric machine 1 is configured to operate in motor mode and in generator mode. In this case, it is a permanent-magnet synchronous motor for propelling an electric vehicle.

Each rotor 3, 4 comprises a plate 5 holding a plurality of permanent magnets 7 having an outline substantially in the shape of a disk sector, as illustrated in FIG. 12.

The magnets 7 have a thickness that is less than the thickness of the plate 5, these thicknesses being measured along the axis of rotation X.

The stator 2 comprises:
a plurality of electrical windings 10, which can be seen in particular in FIGS. 4 and 8,
a plurality of teeth 11 each holding one of the electrical windings 10,
a multifunctional support 12, or interconnection support, configured to hold the plurality of teeth 11, this multifunctional support 12 being provided with electrical interconnection conductors 14 arranged to be connected to the electrical windings 10.

The windings 10 on the teeth 11 together form an overall winding of the stator, for example of the three-phase type. These windings 10 are formed by turns of electrical wires around each tooth 11.

Each tooth 11 comprises a radial stack of grain-oriented electrical steel laminations.

The orientation of the grains is parallel to the axis of rotation.

As a variant, each tooth 11 is made from soft magnetic composite (SMC), in particular obtained by sintering.

The windings 10 are configured to be electrically powered so as to generate a magnetic field capable of producing, with the rotors 3 and 4 of the axial flux electric machine 1, an output torque.

An epoxy resin can be deposited on the turns of the windings 10.

The multifunctional support 12 comprises a central hub 18 and an outer ring 19, and radial branches 20 extend radially between this central hub 18 and the outer ring 19.

In the example described, the multifunctional support 12 comprises a one-piece body 48, in particular made from plastic by molding, and this one-piece body 48 comprises the radial branches 20, the hub 18, and the outer ring 19.

The central hub 18 comprises a central opening 21 configured to allow a rotary shaft 23 connected to the rotors 3 and 4 of the axial flux electric machine 1 to pass through.

The outer ring 19 comprises an outer skirt 25 and an inner skirt 26 that are concentric, both having a cylindrical shape having an axis parallel to the axis of rotation X.

The radial branches 20 are connected to the inner skirt 26 of the outer ring 19. The radial branches 20 thus extend between the central hub 18 and this inner skirt 26 of the outer ring 19.

As can be seen clearly in FIG. 5, the inner skirt 26 and the outer skirt 25 are connected to each other by a planar circumferential band 27 so that the outer ring 19 has a U-shaped transverse cross-section.

The electrical interconnection conductors 14 are placed between the inner skirt 26 and the outer skirt 25 of the outer ring 19.

As illustrated in FIGS. 9 and 17, each electrical interconnection conductor 14 comprises a circular flat conductive bar 15, to which are connected eight electrical connection tabs 16 arranged to be connected to the electrical wires forming the windings 10. These electrical connection tabs 16 are positioned evenly on the flat conductive bar 15 and extend axially, parallel to the axis of rotation X.

The eight electrical windings 10 associated with each electrical interconnection conductor 14 belong to a single electrical phase. In the example described, three electrical interconnection conductors 14 associated with three electrical phases, and one electrical interconnection conductor 114 forming the electrical neutral, are provided. This electrical interconnection conductor 114 comprises electrical connection tabs 116. The four electrical interconnection conductors 14 and 114 are positioned one above the other, with a space between them to avoid electrical contact between them.

A neutral electrical bar is also provided, having an annular shape, with electrical connection tabs 29 (visible in FIG. 8 for example) for each electrical winding 10.

As illustrated in FIGS. 4 and 5, a compartment 30 formed on the outer ring 19 is configured to receive three electrical output ends 17 of the three conductive bars 15 so as to enable the electrical connection of these conductive bars 15 to an external electrical device in order to supply the three-phase current to the stator 2.

The compartment 30 with the three electrical output ends 17 is incorporated into an electrical connector 32 of the axial flux electric machine 1.

The conductive bars 15 are embedded in a resin 31 deposited in the outer ring 19 between the inner skirt 26 and outer skirt 25 thereof. The electrical connection tabs 16 are left free, that is, not embedded in the resin 31.

The multifunctional support 12 comprises a plurality of seats 33 on each of which a tooth 11 bears.

The tooth seats 33 are evenly positioned about the axis of rotation X.

Each seat 33 is delimited by two radial branches 20 of the multifunctional support 12 so that each tooth 11 is circumferentially positioned between two neighboring radial branches 20, which extend along two geometric radii of the multifunctional support 12.

As illustrated in FIG. 10, each tooth 11 comprises a core 34 around which the electrical winding 10 is formed and extending along the axis of rotation X and, at each axial end thereof, an end portion 35 extending transversely to the core 34.

Each end portion 35 substantially defines a T shape with the core 34. The two end portions 35 of the tooth 11 are symmetrical to each other along a plane of symmetry perpendicular to the core 34 and to the axis of rotation X.

Each end portion 35 has an outer main face 36 that is generally planar and oriented in the opposite direction to the core 34.

This outer main face 36 extends perpendicularly to the axis of rotation X, and has a substantially trapezoidal perimeter. In one variant, not illustrated, this perimeter can be rectangular for example, and each radial branch 20 can have a variable width when the branch is followed from the center outward, so that each branch follows the rectangular shape of the outer main face 36 of the tooth. The radial branch must thus be understood in the broad sense, as being able to have a constant or variable width, and optionally a direction that departs from a geometric radius of the multifunctional support 12.

An electrical insulator, in the form of an insulating sheet or an insulating coating, is interposed between the core 34 of each tooth 11 and the winding 10.

The end portion 35 of the tooth 11 extends in a circumferential space 38 between two neighboring radial branches 20 of the multifunctional support 12.

The end portion 35 of the tooth 11 passes through this circumferential space 38, coming substantially flush with the radial branches 20 on the air gap side.

On the air gap side, the end portion 35 of the tooth 11 thus does not protrude axially beyond the radial branches 20, and the outer main face 36 of the end portion 35 of the tooth 11 substantially continues on from the radial branches 20.

Each tooth 11 is thus axially close to the neighboring rotor 3 or 4, which makes it possible to reduce the air gap between the stator 2 and the rotor 3 or 4.

The radial branches 20 are straight and flat, and extend perpendicularly to the axis of rotation X.

Each seat 33 of the multifunctional support 12 comprises a pair of a first bearing zone 40 and a second bearing zone 41 on which the end portion 35 of the tooth bears, as can be seen in FIGS. 7 and 8.

In FIG. 8, one of the teeth 11 has not been shown in order to show the corresponding seat 33 more clearly.

The first bearing zone 40 of this pair of bearing zones is formed on the outer skirt 25 of the outer ring 19.

The second bearing zone 41 of this pair of bearing zones is formed on the central hub 18.

These first and second bearing zones 40 and 41 are thus spaced apart from each other in the radial direction, and the end portion 35 of the tooth comprises a radially inner edge 43 and a radially outer edge 44 respectively bearing on the first and second bearing zones 41 and 40.

The end portion 35 of the tooth comprises two circumferentially spaced apart lateral edges 45 that form, with the radially inner and radially outer edges 43 and 44, the perimeter of this end portion 35.

The two lateral edges 45 of the end portion 35 of the tooth are facing the circumferential space 38 between two neighboring radial branches 20 of the multifunctional support 12.

In other words, the end portion 35 of the tooth does not bear on the radial branches 20 of the multifunctional support 12, but only on the first and second bearing zones 40 and 41.

Each bearing zone 40 and 41 is a circumferential band that extends from one of the radial branches 20 to one of the neighboring radial branches 20. These first and second bearing zones 40 and 41 are axially offset relative to the radial branches 20 so that the end portion 35 of the tooth can, by abutting on these first and second bearing zones 40 and 41, be inserted into the circumferential space 38 between two radial branches 20.

The radial dimension of the bearing zone 40, 41 is less than 20%, in particular less than 10%, of the radial dimension of the radial branch. The bearing zone 40, 41 thus has a fairly small radial dimension compared to that of the radial branches 20.

The multifunctional support 12 comprises, for each seat 33, two facing positioning reliefs 46 protruding into the circumferential space 38, these positioning reliefs 46 being arranged to interact with the end portion 35 of the tooth 11.

Each positioning relief 46 takes the form of a ridge and extends from one of the radial branches 20, in particular substantially in the middle of this radial branch 20.

The stator 2 comprises a housing 50 (shown in isolation in FIG. 11) configured to interact with the multifunctional support 12 so as to trap the teeth 11 between this multifunctional support 12 and this housing 50.

The housing 50, produced by molding a plastic material or molding an aluminum alloy, and the multifunctional support 12, are fastened together by means of screws.

The multifunctional support 12 is fully housed in an inner volume 51 of the housing 50.

A cover 52, generally flat, is provided to close the inner volume 51 of the housing 50.

This cover 52 is fastened to an annular end edge 53 of the housing 50 by means of screws. An annular seal is interposed between this cover 52 and this annular end edge 53 of the housing 50.

The rotor 4 is housed in the housing 50 and is positioned axially between the multifunctional support 12 and this cover 52.

The housing 50 comprises a plurality of seats 55 on each of which a tooth 11 bears.

The seats 55 of the housing 50 are evenly positioned about the axis of rotation X.

Each tooth 11 is thus sandwiched between a seat 55 of the housing 50 and a seat 33 of the multifunctional support 12.

The seat 55 of the housing 50 and the seat 33 of the multifunctional support 12 have an identical surface.

Each seat 55 of the housing 50 is delimited by two radial branches 56 of the housing 50.

Each tooth 11 is positioned circumferentially between two neighboring radial branches 56.

The end portion 35 of the tooth 11 extends in a circumferential space 57 between two neighboring radial branches 56 of the housing 50.

The tooth 11 is thus axially close to the neighboring rotor 3, which makes it possible to reduce the air gap between the stator 2 and the rotor 3.

The rotor 3 is placed facing the radial branches 56 of the housing 50, outside the housing 50.

The end portion 35 of the tooth passes through the circumferential space 57, coming substantially flush with the radial branches 56 on the side of the air gap with the rotor 3.

On the side of the air gap with the rotor 3, the end portion 35 of the tooth thus does not protrude axially beyond the radial branches 56, and the outer main face 36 of the end portion 35 of the tooth substantially continues on from the radial branches 56.

The radial branches 56 of the housing 50 are straight and flat, and extend perpendicularly to the axis of rotation X.

The radial branches 56 are each provided with a reinforcing rib 58. Each radial branch 56 thus has a T-shaped transverse cross-section.

This rib 58 extends between two neighboring teeth 11.

The housing 50 comprises an inner annular wall 60 and an outer annular wall 61, and the radial branches 56 defining the seats 55 extend radially between this inner annular wall 60 and the outer annular wall 61.

The inner annular wall 60 of the housing 50 comprises a central opening 67 configured to allow a rotary shaft 23 connected to the rotors 3 and 4 of the axial flux electric machine 1 to pass through.

The housing 50 is arranged to hold ball bearings 69 that serve as a bearing for the rotary shaft 23.

The housing 50 comprises an inner annular shoulder 68 on which the multifunctional support 12 bears.

This inner annular shoulder 68 is formed on the outer annular wall 61 of the housing 50.

The seat 55 for each tooth 11 comprises two bearing zones 63 and 64 that are radially spaced apart from each other.

The bearing zone 63 of the seat 55 is formed on the inner annular wall 60.

The bearing zone 64 of the seat 55 is formed on the outer annular wall 61.

Each bearing zone 63, 64 is a circumferential band that extends from one of the radial branches 56 to one of the neighboring radial branches 56.

The radially inner edge 43 of the end portion 35 of the tooth 11 bears on the bearing zone 63 of the seat 55.

The radially outer edge 44 of the end portion 35 of the tooth 11 bears on the bearing zone 64 of the seat 55.

The two lateral edges 45 of the end portion 35 of the tooth are facing the circumferential space 57 between two neighboring radial branches 56 of the housing 50.

In other words, the tooth 11 does not bear on the radial branches 56 of the housing 50, but only on the two bearing zones 63 and 64.

The radial dimension of the bearing zone 63, 64 is less than 20%, in particular less than 10%, of the radial dimension of the radial branch 56.

The bearing zone 63, 64 thus has a fairly small radial dimension compared to that of the radial branches 56.

A multifunctional support 70 and teeth 71 according to another exemplary embodiment of the invention will now be described with reference to FIGS. 13 to 16.

This multifunctional support 70 is similar to the multifunctional support 12 described above, with the exception of the seats 72 for the teeth 71, which seats 72 differ from the seats 33 of the preceding example.

The teeth 71 are similar to the teeth 11 of the preceding example, with the exception of the end portions 73, which differ from the end portions 35 of the preceding example.

With respect to the seat 72 of the multifunctional support 70, said seat comprises two bearing zones 74 that are circumferentially spaced apart from each other, and the end portion 73 of the tooth 71 comprises two lateral edges 76 circumferentially spaced apart from each other, each bearing on one of the bearing zones 74 of the seat 72.

The end portion 73 of the tooth 71 comprises a radially inner edge 77 and a radially outer edge 78 that form, with the lateral edges 76, the perimeter of this end portion 73 of the tooth 71.

The radially inner edge 77 and the radially outer edge 78 of the end portion 73 of the tooth are facing the circumferential space 79 between two neighboring radial branches 80 of the multifunctional support 70.

In other words, the tooth 71 does not bear on the central hub 18 and the outer ring 19 of the multifunctional support 70, but only on the two bearing zones 74.

These two bearing zones 74 of the seat 72 are respectively formed on two neighboring radial branches 80.

Each bearing zone 74 is a radial band that extends on one of the radial branches 80, substantially from the central hub 18 to the outer ring 19.

Two bearing zones 74 are thus formed on each radial branch 80, for two neighboring teeth 71 respectively.

Each radial branch 80 comprises a reinforcing rib 81 that is radial and extends, in a straight line, between the two neighboring bearing zones 74 of this radial branch 80.

Each radial branch 80 thus has a T-shaped cross-section.

The end portion 73 of the tooth 71 comprises, along each lateral edge 76, a shoulder 83 configured to bear on one of the bearing zones 74 of the seat, and between these shoulders 83, the end portion 73 of the tooth 71 extends in the circumferential space 79 between two neighboring radial branches 80 of the multifunctional support 70.

The seats and the radial branches on the housing are symmetrical to the seats 72 of the multifunctional support 70, and will not be described further.

In the example described, each circumferential space 79 is associated with two facing positioning reliefs 85, belonging respectively to the central hub 18 and the outer ring 19 of the multifunctional support 70.

These positioning reliefs 85, in the form of ridges, serve to position the tooth 71 in the circumferential space 79.

In the example described, each end portion 73 has an outer main face 86 that is oriented in the opposite direction to the core 34 and comprises a groove 90 in a central region 91 of this outer main face 86, this groove 90 being configured to reduce the torque ripple that may occur during the operation of the axial flux electric machine.

Central region 91 of the outer main face 86 of the end portion 73 of the tooth denotes a region that is circumferentially spaced apart from the two lateral edges 76 of the end portion. The end portion 73 of the tooth defines two tooth feet 89 that protrude on either side of the core 34, which gives the T shape of the core 34 with the end portion 73.

The two ends of each groove 90 join the radially inner edge 77 and the radially outer edge 78 of the end portion 73.

The groove 90 thus continuously passes fully across the center of the outer main face 86 of the end portion 73 of the tooth, from the radially inner edge 77 to the radially outer edge 78 thereof.

The groove 90 forms a straight line along a radial direction of the stator 2.

In one variant, not shown, the groove 90 extends in a curved shape, for example with one or more rounded bends.

Each groove 90 is formed by a channel 93 on the outer main face 86 of the end portion 73 of the tooth.

The channel 93 has a depth ef substantially equal to half of the thickness ep of the end portion 73 of the tooth 71. This depth and this thickness are measured parallel to the axis of rotation X, in the central region 91. The thickness ep corresponds to the maximum thickness of the tooth feet 89.

The groove 90 has a rectangular shape in transverse cross-section. As a variant, this cross-section can be trapezoidal or semi-circular.

In another exemplary embodiment of the invention illustrated in FIGS. 18 and 19, each groove 90 of a tooth 111 is configured to interact with a positioning relief that is an intermediate radial branch 151 of a multifunctional support or a housing 150 of the stator. The intermediate branch 151 passes through the middle of the associated seat 133.

1. A stator of an axial flux electric machine, the axial flux electric machine having an axis of rotation, the stator comprising:
a plurality of electrical windings,
a plurality of teeth each holding one of the electrical windings,
a multifunctional support, or interconnection support, configured to hold the plurality of teeth, this multifunctional support being provided with electrical interconnection conductors arranged to be connected to the electrical windings.

2. The stator as claimed in claim 1, wherein the multifunctional support comprises a plurality of seats on each of which a tooth bears.

3. The stator as claimed in claim 2, wherein each seat is delimited to two radial branches of the multifunctional support.

4. The stator as claimed in claim 3, wherein each tooth comprises a core around which the winding is formed and extending along the axis of rotation and, at each axial end thereof, an end portion extending transversely to the core, and this end portion of the tooth extends at least partially in a circumferential space between two neighboring radial branches of the multifunctional support.

5. The stator as claimed in claim 3, wherein the multifunctional support comprises a central hub and an outer ring, and the radial branches defining the seats extend radially between this central hub and the outer ring.

6. The stator as claimed in claim 2, wherein the seat of each tooth comprises at least one bearing zone on which the tooth bears, in particular an end portion of the tooth.

7. The stator as claimed in claim 6, wherein the bearing zone of the seat is formed on the central hub or the outer ring or one of the radial branches of the multifunctional support.

8. The stator as claimed in claim 7, wherein the seat of each tooth comprises at least two bearing zones on which the tooth bears, in particular an end portion of the tooth.

9. The stator as claimed in claim 8, wherein the two bearing zones of the seat are radially spaced apart from each other, and the end portion of the tooth comprises a radially inner edge and a radially outer edge each bearing on one of the bearing zones of the seat.

10. The stator as claimed in claim 8, wherein the two bearing zones are circumferentially spaced apart from each other, and the end portion of the tooth comprises two lateral edges circumferentially spaced apart from each other, each bearing on one of the bearing zones of the seat.

11. The stator as claimed in claim 1, wherein each tooth comprises a core around which the winding is formed and extending along the axis of rotation and, at each axial end thereof, an end portion extending transversely to the core, the end portion having an outer main face that is oriented in the opposite direction to the core and comprises a groove in a central region of this outer main face, which central region is circumferentially spaced apart from two lateral edges of the end portion, this groove being configured to reduce the torque ripple that may occur during the operation of the axial flux electric machine.

12. The stator as claimed in claim 11, wherein each groove is configured to interact with a positioning relief of a multifunctional support or of a housing of the stator, this positioning relief comprising in particular an intermediate radial branch of the multifunctional support or of the housing.

13. The stator as claimed in claim 1, wherein the multifunctional support comprises at least one positioning relief protruding into the circumferential space between two neighboring radial branches of the multifunctional support, this positioning relief being arranged to interact with the tooth, in particular the end portion of the tooth.

14. The stator as claimed in claim 5, wherein the multifunctional support comprises a one-piece body, in particular made from plastic, in particular by molding, and this one-piece body comprises the radial branches, the hub, and the outer ring.

15. The stator as claimed in claim 1, wherein the stator comprises a housing configured to interact with the multifunctional support so as to trap the teeth between this multifunctional support and this housing, the housing in particular comprising a plurality of seats on each of which a tooth bears.

16. The stator as claimed in claim 4, wherein the radial branches of the multifunctional support are axially set back from the end portions of the teeth, or are flush with the end portions of the teeth.

17. The stator as claimed in claim 1, wherein each tooth of the plurality of teeth is in one piece.

18. An axial flux electric machine, in particular of the permanent magnet type, comprising a stator as claimed in claim 1, and at least one rotor positioned face to face with the stator, in the axial direction.

19. The stator as claimed in claim 4, wherein the multifunctional support comprises a central hub and an outer ring, and the radial branches defining the seats extend radially between this central hub and the outer ring.

20. The stator as claimed in claim 3, wherein the seat of each tooth comprises at least one bearing zone on which the tooth bears, in particular an end portion of the tooth.
